(19) United States
(12) Patent Application Publication
(10) Pub. No.: US 2003/0088755 A1
(43) Pub. Date: May 8, 2003

(54) Method and apparatus for the data-driven synschronous parallel processing of digital data

(76) Inventors: Daniel Gudmunson, Newmarket (CA); Alexei Krouglov, Markham (CA); Robert Coleman, Aurora (CA)

Correspondence Address: Mark B. Eisen, c/o Dimock Stratton Clarizio, Suite 3202, Box 102, 20 Queen Street West, Toronto, ON, M5H 3R3, CA

(21) Appl. No.: 09/986,262

(22) Filed: Nov. 8, 2001

(51) Int. Cl. G06F 15/00

(52) U.S. Cl. 712/25; 712/201

(57) ABSTRACT

A method and apparatus for the data-driven synchronous parallel processing of digital data, which temporally separates the processes of instructions distributions and data requests from the process of actual data processing. The method includes the steps of: dividing the stream of digital data into data packets, consecutively distributing instructions to data processing units before their execution, consecutively synchronously processing data packets by multiple data processing units processing in parallel, and synchronization of parallel multiple data processing units by data tokens attached to the data packets. In the preferred embodiment the method comprises one or more of the steps of: storing instructions inside the data processing units, requesting data before the start of data processing, storing records for requested data packets, associating received data with the records of data requests, attaching to each data packet a validity signal (data token) indicating the validity or non-validity of the received data for processing, and extension of data buffers coupled to the data processing units into elastic data buffers capable of absorbing variations in the data rate. The method provides a data-driven synchronization of parallel synchronous multiprocessor system and a substantially non-stalling flow of digital data through a digital data processor, and the apparatus includes a programmable apparatus which implements the method. In the preferred embodiment a data buffer is provided between adjacent data handling units, and the invention manipulates the timing of the buffer's emptiness and fullness signals, processing each data packet coming into buffer in accordance with its validity signal (data token), and associating a validity signal (data token) with the data packet sent out from buffer.

### FIELD OF THE INVENTION

The present invention relates to the field of data processors system organization, and in particular relates to data processors containing a plurality of interconnected modules combined in a multi-processing system.

### BACKGROUND OF THE INVENTION

The multiprocessing system is one of the systems employed for improving the performance and reliability of a single processor system. Various types of such systems have thus far been proposed. Great advances in semiconductor technology have provided cheap and high performance large-scale integration processors, resulting in easier hardware design of the multi-processor system.

It is said that a multi-processor system with a combination of n processors cannot produce an upgrade of the performance by n-times that of the single processor. The major causes for drawback of the performance improvement are, for example, conflicts in access to the main storage used in common among the processors, the conflict control associated with common use of the resource, and an increase of the overhead arising from the communication among the processors. Also important is that conventionally all execution steps of the operating system (OS) are sequentially processed by one single processor.

As used herein the term parallel processing refers to a single program that runs on multiple processors simultaneously. In relation to the level of parallelism among instructions and data there are four categories of processors: SISD (single instruction stream, single data stream), SIMD (single instruction stream, multiple data streams), MISD (multiple instruction streams, single data stream), and MIMD (multiple instruction streams, multiple data streams). Another important concept is the granularity of parallel tasks. A large grain system is one where operations running in parallel are fairly large, in the order of programs. Small grain parallel systems divide programs into small pieces, up to few instructions.

To take advantage of multiprocessing, conventional multiprocessor systems utilize deep pipelining where processing tasks are broken into smaller subtasks, each subtask is executed by the distinct processing unit, and all or some processing units are working in parallel. Another technique used in conventional multiprocessor systems is to replicate the internal components of a processor so it can start doing multiple data processing tasks at the same time. This technique is called the superscalar execution. The third technique deployed in conventional multiprocessor systems is dynamic scheduling, wherein data processing tasks are allowed to be scheduled for processing out of order in order to avoid the stall of a processor due to memory fetching and computational delays. In practice these techniques may be combined together as well as with other techniques such as, for example, branch prediction.

Parallel multiprocessor systems are distinct as well according to their memory organization. In one type of system, known as a shared memory system, there is one large virtual memory, and all processors have equal access to data and instructions in this memory. The other type of system is a distributed memory, in which each processor has a local memory that is not accessible to any other processor. The processors also can be connected by a single bus or via networks.

Among architectures of multiprocessor systems are vector processors, which operate on the vector values rather than the scalar values. Such processors are closely related to the SIMD category of processors, and contain the control unit responsible for fetching and interpreting instructions and several data processing units. Another class of multiprocessor systems is superscalar processors, which operate on scalar values but are capable of executing more than one instruction at a time. This is possible because superscalar processors contain an instruction-fetching unit capable of fetching more than one instruction at the same time, an instruction-decoding logic capable of distinguishing independent instructions, and multiple data processing units able to process several instructions simultaneously.

An important aspect of microprocessor architecture is the asynchronous or synchronous character of the processor. An asynchronous processor can start and finish data handling at any moment in time. A synchronous processor synchronizes its operation with an internal clock. The present invention relates to a synchronous microprocessor architecture.

In multiprocessor systems, a primary consideration is how the work of multiple processors will be synchronized. There are two distinct approaches to solving this problem. The first is to build self-timed system, which has some internal mechanism telling each processor when it has to start processing. The other approach utilizes external scheduling, where each processor receives a signal indicating the start of processing from an external device such as, for example, an operating system. The present invention relates to a self-timed multiprocessor system.

One of the known mechanisms for providing the function of a self-timed asynchronous multiprocessor system is a so-called “data-driven processor,” where data packets moving between multiple processors are accompanied by the data tokens. This non-conventional, non-von Neumann architecture was designed for clockless (asynchronous) multiprocessor systems, wherein arrival of data tokens serves as a trigger starting the work of each data processor.

Unlike previous systems, the present invention uses a data-driven multiprocessor architecture to effect the parallel operation of a synchronous multiprocessor system.

### SUMMARY OF THE INVENTION

The present invention provides a method and apparatus for performing a non-stalling synchronous parallel processing of digital data, and a non-stalling synchronous data flow through a digital data processor.

Unlike prior art methods, the method of the invention allows for non-stalling synchronous digital data processing by separating the process of distributing instructions and delivering data to data processing units from the actual process of data processing. To accomplish this, the invention provides data tokens for self-synchronization of the parallel operation of a multiprocessor system and its subsystems.

The proposed invention conceptually utilizes a deep pipelining technique combined with vector processing, whereby processing tasks have been divided among parallel data processing units with coarse granularity. The method and apparatus of the invention separates the task of instruction processing and the task of data processing, which decreases the number of stalls in the pipelined stages of data processing, and thus achieves an increase in the multiprocessor system's performance.

According to the method of the invention, digital data is divided into distinct pieces (data packets), and each piece of data is consecutively processed by multiple data processing units, while all data processing units are work in parallel. The instructions for data processing are sent to the data processing units before the data processing units are actually available to start processing the data. In the preferred embodiment the data processing units internally store instructions records for future reference, and send out data requests with the address of the requesting data processing unit while internally storing the data requests records as well. The returning pieces of data previously requested each comprise a validity signal preferably comprising a data token, and are put into an internal buffer from which they are retrieved for further processing. The corresponding record from the list of outstanding data requests is cancelled after the requested piece of data arrives, and the instruction record obtains a special indication that this piece of data is inside the data processing unit and available for processing. The data packet is taken from the buffer, the corresponding instruction record is retrieved, the data is processed according to the instruction, and the result is sent out.

An apparatus implementing the proposed method comprises a digital data processor including in particular the following components: a module for receiving instructions and/or digital data from one or more external devices and sending instructions and/or digital data to one or more external devices, an instruction path inside the processor, a data path inside the processor, a row of data processing units organized for parallel processing of digital data, and a module for consecutively processing and distributing instructions to the data processing units.

In further aspects the data processing unit in the device of invention also preferably has the following components: a storage for storing a list of instruction records, a storage for storing outstanding data requests records, a storage for receiving incoming data, and a computation module for data processing. The data processing unit also has control logic, which provides the appropriate instruction and data flows through the data processing unit.

In the preferred embodiment the digital data processing device according to the invention includes the support required for a non-stalling synchronous data-driven flow of digital data through the digital data processor. The invention provides a method and apparatus for such data flow which preferably comprises the steps of: providing a data buffer between adjacent data handling units, processing the incoming data according to a data validity signal (data token), providing a data validity signal (data token) for the outgoing data, providing a signal indicating the data buffer's fullness from the data buffer to previous adjacent unit, providing a signal indicating buffer's emptiness from the data buffer to next adjacent unit, asserting the data buffer's fullness signal in advance of filling the data buffer, asserting the data buffer's emptiness signal in advance of depleting the data buffer, and programming the timing of asserting the buffer's fullness and emptiness signals to allow for digital data flow management according to the system's configuration.

The invention is applicable to a processor suitable for a single processor system or a multiprocessor system.

The present invention thus provides a method for data-driven synchronous parallel processing of a stream of data packets by multiple data processing units working in parallel, comprising the steps of: a. distributing at least one instruction for data processing to one data processing unit of the multiple data processing units, before the data processing unit is available to process the instruction; b. storing the instruction in an execution instructions memory; c. sending from the one data processing unit a data request for at least one data packet corresponding to the instruction, required to execute the instruction; d. storing a record of the at least one data packet requested; e. associating with the at least one data packet an address of the one data processing unit; f. associating with the each data packet sent out a data token showing the readiness of the packet for further processing; g. when the at least one data packet is received by the processing unit, associating the data packet with the corresponding instruction and distributing the data packet to the one data processing unit; and h. processing the data according to the corresponding instruction.

In further aspects of the method for data-driven synchronous parallel processing: instructions are distributed to the multiple data processing units consecutively; instructions are distributed to the multiple data processing units concurrently; the method includes, after step f., the step of putting the requested data packets into an internal data buffer in a data processing unit; the method includes, after step g., the step of erasing the record of the data request corresponding to the data packet; the method includes, during step g., the step of sending to the corresponding instruction in the execution instructions memory an indication that the at least one data packet has been received by the processing unit and is available for processing; the method includes, during step e., the step of associating with the data packets an address of its sender and, during the step g, associating the data packet with the corresponding instruction according to the address of the data packet sender; the method includes, during the step g, associating the data packet with the corresponding instruction according to the order of the data packet received; the method includes the step of retrieving each data packet from the internal data buffer to be processed according to the corresponding instruction; an output of the processing step is sent to another data processing unit or out of the processor, or both; and/or processing occurs in real-time.

The present invention further provides a method of providing a substantially non-stalling sequential flow of data packets through a digital data-driven processor, the digital processor storing at least one instruction for processing data packets in accordance with the instruction, comprising the steps of a. providing a buffer between adjacent units processing, distributing or otherwise handling the data; b. providing a fullness signal indicating a fullness state of the buffer from the data buffer to a previous adjacent unit, before the buffer is full; c. providing an emptiness signal indicating an emptiness state of the buffer from the data buffer to a next adjacent unit, before the buffer is empty; d. providing an incoming data validity signal for synchronization of data handling by the buffer with the arrival of a data packet to the buffer; and e. providing an outgoing data validity signal for synchronization of data handling by a unit next after the buffer with an outgoing data packet from the buffer, wherein assertion of the fullness signal in advance of filling the buffer allows the buffer to absorb data packets in transit between a previous unit sending the data and the buffer receiving the data, and assertion of the emptiness signal in advance of depleting the buffer allows for the processor to request new data packets before the buffer becomes empty.

In further aspects of the method of providing a substantially non-stalling sequential flow of data packets through a digital data-driven processor: the validity signal comprises a data token; and/or the method is performed in a processor having a plurality of processing units, and includes the step of programming a timing of assertion of the fullness signal and of the emptiness signal to allow for management of synchronous data flow to the processing units.

The present invention further provides an apparatus for substantially non-stalling synchronous data packet flow through a digital data-driven processor, each data packet being associated with an address of a processing unit containing an instruction for processing the data packet, comprising a data buffer for temporary storage of the data packets, the buffer comprising an input port for receiving incoming data packets and their associated addresses; an output port for sending out outgoing data and their associated addresses; an input port for receiving an incoming validity signal; an output port for sending an outgoing validity signal; an outgoing fullness signal indicating a fullness of the buffer, adapted to be asserted in advance of the filling of the buffer; an outgoing emptiness signal indicating an emptiness of the buffer, adapted to be asserted in advance of the depletion of the buffer; and control logic for regulating a timing of assertion of the fullness and the emptiness signals in a multi-processing system.

The present invention further provides an apparatus for substantially non-stalling data-driven synchronous parallel processing of data packets including a digital data processor, further comprising: an interface for receiving instructions and digital data from at least one external device and sending instructions or digital data or both to at least one external device; an instruction path contained inside the processor; a data path contained inside the processor; a plurality of data processing units organized for parallel processing of the data; and a distributing unit organized for distributing one or more instructions at a time to the data processing units.

In further aspects of the apparatus of the invention: the validity signal comprises a data token; the buffer comprises a FIFO buffer; instructions are distributed to the plurality of data processing units consecutively; instructions are distributed to the plurality of data processing units concurrently; each data processing unit comprises a storage for instructions, a storage for records of outstanding data requests, a storage for receiving requested data packets, and a computation module for processing the requested data packets in accordance with at least one associated instruction; the apparatus comprises control logic for controlling instruction and data flows through the processor; the digital data processor comprises a general-purpose; the digital data processor comprises a graphics processor; the digital data processor comprises a digital signal processor; the computational module operates using vector values; and/or the computational module operates using scalar values.

The present invention further provides a method for data-driven synchronous parallel processing of a stream of data packets by multiple data processing units working in parallel, comprising the steps of: a. distributing at least one instruction for data processing to one data processing unit of the multiple data processing units, before the data processing unit is available to process the instruction; b. storing the instruction in an execution instructions memory; c. sending from the one data processing unit a data request for at least one data packet corresponding to the instruction, required to execute the instruction; d. storing a record of the at least one data packet requested; e. associating with the at least one data packet an address of the one data processing unit; f. associating with the at least one data packet a data token indicating a readiness of the data packet for further processing and comprising data for associating the at least one data packet with the corresponding instruction at the one data processing unit; g. when the at least one data packet is received by the processing unit, associating the data packet with the corresponding instruction and distributing the data packet to the one data processing unit; and h. processing the data according to the corresponding instruction.

### BRIEF DESCRIPTION OF THE DRAWINGS

In drawings which illustrate by way of example only a preferred embodiment of the invention,

FIG. 1 is a schematic diagram showing a comparison of conventional consecutive and parallel multiprocessing techniques.

FIG. 2 is a schematic diagram showing an example of consecutive multiprocessing by parallel Data Processing Units according to the invention.

FIG. 3 is a schematic diagram showing an example of the system organization of a processor with multiple Data Processing Units according to the invention.

FIG. 4 is a top-level block diagram of a Data Processing Unit in FIG. 3.

FIG. 5 is a schematic illustration of an Elastic Buffer according to the invention.

### DETAILED DESCRIPTION OF THE INVENTION

The invention is applicable to the organization of digital data processing units, and in particular to the organization of multiple data processing units connected together.

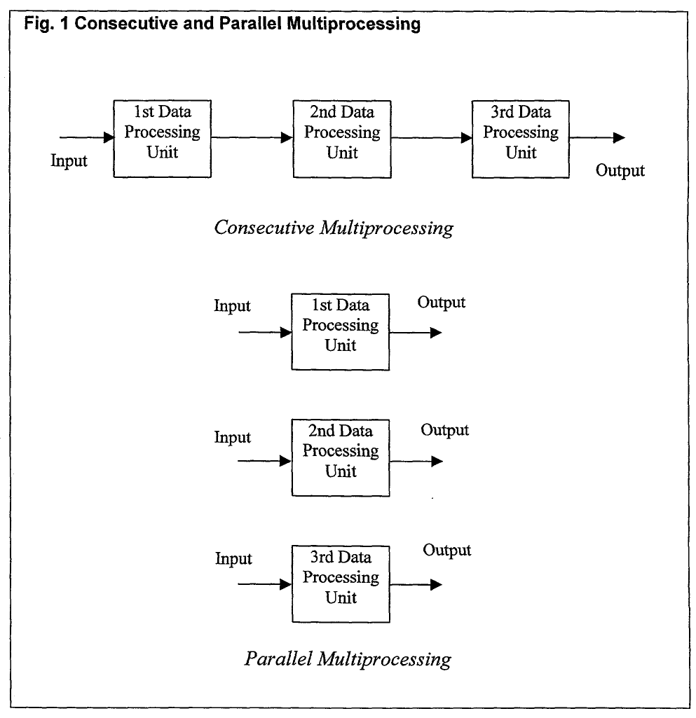

The interconnection of data processing units may be organized such that the data processing units process digital data either consecutively or in parallel, or in a mixed consecutive-parallel manner. Examples of the consecutive and parallel organization of multiple data processing units are shown schematically in FIG. 1.

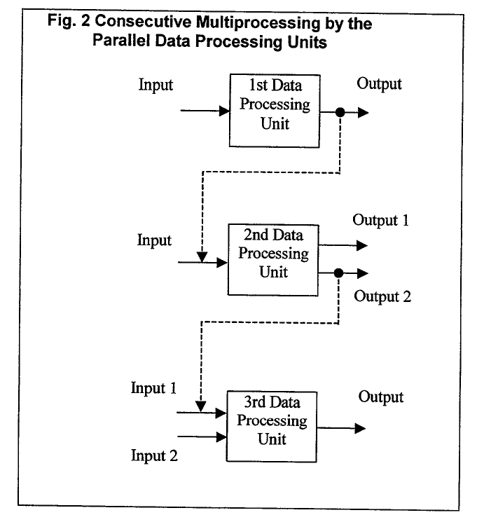

To take advantage of the data processing capabilities of multiple data processing units during consecutive processing, it is beneficial to have the processors working in parallel. This may be accomplished by dividing the digital data stream into a sequence of distinct segments or pieces, for example data packets, having each data processing unit process a piece of data, and sending the outcome of one data processing unit out, and/or to another data processing unit for consecutive processing. FIG. 2 shows an example of multiple data processing units organized to carry out consecutive processing of digital data by working in parallel.

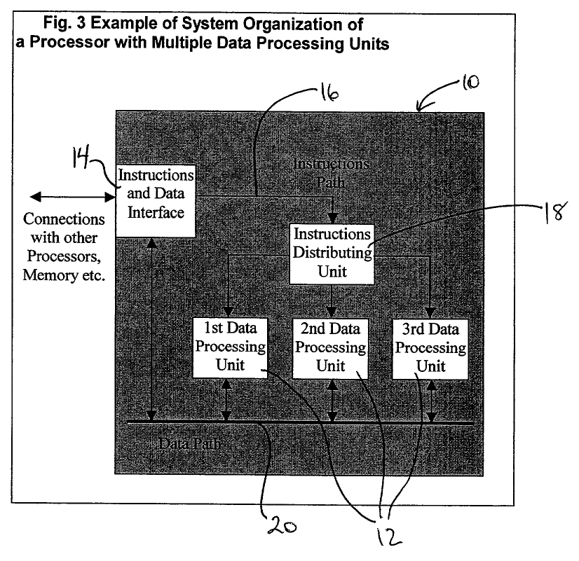

FIG. 3 illustrates an example of the system organization of a processor 10 according to the invention, containing multiple data processing units 12, where processor 10 may for example be general-purpose microprocessors, graphics processors, digital signal processors, or otherwise as suitable for the intended application. Each processor 10 may be connected to other processors 10, storage memory (not shown), or other external devices such as a monitor, keyboard etc. (not shown). Processor 10 also comprises Instructions and Data Interface 14, through which the processor 10 receives data to be processed and instructions as to how to process the data. Processor 10 may also receive various control signals (not shown). Instructions are transmitted through Instructions Path 16 to the Instructions Distributing Unit 18 where they are processed and sent to the individual Data Processing Units 12. Data is transmitted through the Data Path 20 from the Instructions and Data Interface 14 to Data Processing Units 12. After data is processed it can be sent via Data Path 20 to other Data Processing Units 12 or to the Instructions and Data Interface 14 to be sent out of the processor 10. Processor 10 may also send out various control signals (not shown).

It will be noted that the system organization shown in FIG. 3 reveals a discrepancy between the consecutive operation of the Instructions Distributing Unit 18 and the parallel operation of the multiple Data Processing Units 12. This is compensated for by the use of data tokens that allow instructions to be processed according to the timing in which valid data packets are received, rather than the order in which the instructions are received, which will be described in more detail following the description of the organization of the Data Processing Units 12.

To process the data, each Data Processing Unit 12 must receive instructions describing where to retrieve the data from, what the Data Processing Unit 12 is required to do with the data, and where to send the result. The need to receive data to be processed can significantly delay the start of actual data processing by a Data Processing Unit 12, especially when data has to be fetched, for example, from an external storage memory. In a conventional parallel processing system this considerably delays processing, as instructions for retrieving data for the next processing operation cannot be issued by the processor until the data for the current processing operation has been received and processed.

In order to avoid decreasing the data processing performance of the processor caused by delays in data retrieval, it is desirable to send the data requests (together with the target address for returning data packets) by the Data Processing Units 12 far in advance of the actual moment when the data has to be available for each Data Processing Unit 12 for processing.

Since the number of outstanding data requests may vary, each Data Processing Unit 12 must maintain a record of such data requests in storage memory. Once the piece of earlier requested data is received by a particular Data Processing Unit 12 in accordance with the address of the data packet, the corresponding data request record can be erased.

To synchronize the start of data processing by a Data Processing Unit 12 with the arrival of the requested data, a special signal (data token) can be attached to the data indicating its validity or non-validity. The arrival of a data token serves as a trigger, which activates the start of data processing by the Data Processing Unit 12 according to the instructions stored inside the Data Processing Unit 12. Thus the work of Data Processing Unit 12 is data-driven, or more specifically, data token-driven.

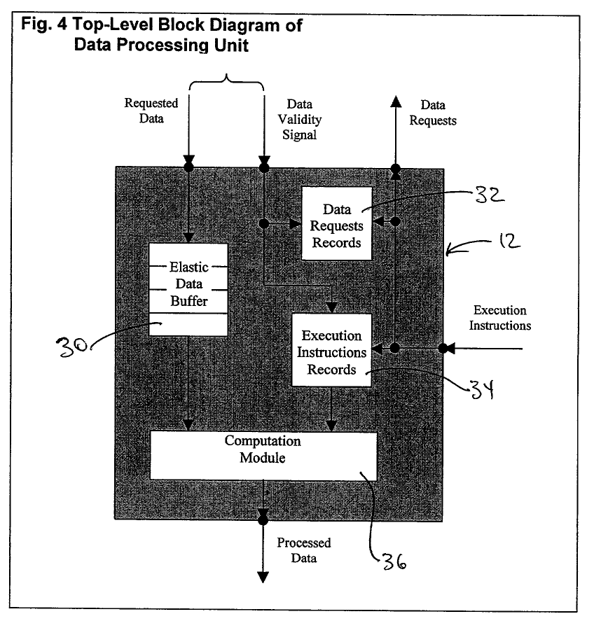

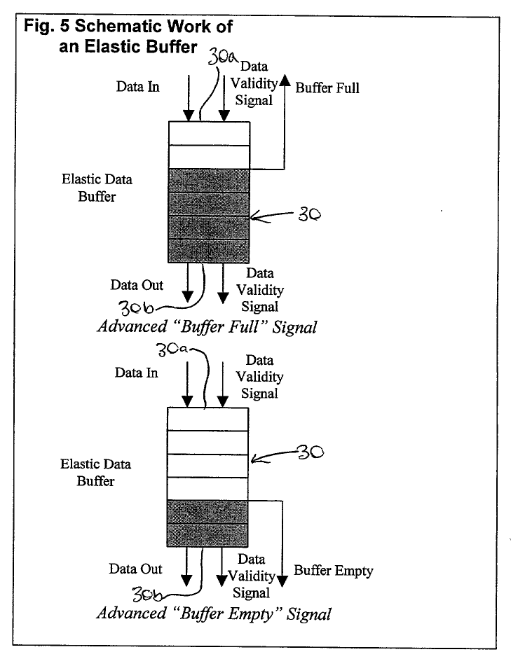

To achieve a non-stalling data-driven synchronous data stream through the Data Path 20, in the preferred embodiment the invention comprises an elastic buffer 30, illustrated in FIGS. 4 and 5, interposed between consecutive units, such as Data Processing Units 12 and Instructions and Data Interface 14, which process, distribute, or otherwise handle the data. The elasticity of the buffer 30 is achieved by manipulating the timing of the assertion of buffer status signals indicating the buffer emptiness and fullness. For example, when the buffer's fullness signal is asserted in advance of the buffer's actual filling it allows for data packets which are in transit to the buffer 30 from the previous unit to be absorbed by the buffer 30. Similarly, the buffer's emptiness signal can be asserted in advance of the buffer's actual depletion, which allows for the Data Processing Unit 12 to request the next required data packets before the buffer 30 is empty. The number of data packets the buffer 30 can accommodate after the fullness signal is asserted and the number of data packets the buffer 30 can send out after the emptiness signal is asserted can be programmed, to manage the data behavior for the multiprocessor system. The management of data behavior can be used for, among other purposes, the management of power consumption inside the processor.

Thus, in the preferred embodiment, to absorb variations in the data rate at which previously requested data packets are delivered to a Data Processing Unit 12 with the rate at which the particular Data Processing Unit 12 processes one data packet, the Data Processing Units 12 are each provided with Elastic Data Buffers 30 to accommodate the incoming data packets. In addition to the data packets and addresses of the respective target Data Processing Units 12, the buffer 30 receives the validity signal (data token) corresponding to each data packet coming in and sends out the validity signal (data token) corresponding to each data packet going out.

FIG. 4 shows the data flow through a preferred Data Processing Unit 12. The Data Processing Unit 12 receives an execution instruction, which describes an operation that the Data Processing Unit 12 is to perform and contains information about the data that the Data Processing Unit 12 has to process. The Data Processing Unit 12 keeps the record of the instruction in the Execution Instructions Records storage 34 for future reference, requests data to perform the data processing operation on, and keeps records of all outstanding data requests in the Data Requests Records storage 32.

Therefore instructions are received by the Instructions and Data Interface 14 of Processor 10 via the processor's external connections, passed to the Instructions Distributing Unit 18 via Instructions Path 16 and distributed to Data Processing Units 12 where each instruction is temporarily stored in the Execution Instructions Records storage 34. The instructions so stored cause the processor 10 to send a request for one or more data packets, with the address of the requesting Data Processing Unit 12, to an internal or external storage device (not shown), in which the requested data resides. A record of the requested data packet is written to the Data Request Records storage 32. The aforementioned process is repeated as further instructions continue to be received by the processor 10.

Previously requested data with the address of each particular data packet is received by the Data Processing Unit 12 via Data Path 20, with an attached validity signal (data token) showing the incoming data validity or non-validity, which associates the pieces of data (data packets) with the instructions that caused the data request. Each incoming data packet is put into the Elastic Data Buffer 30 and the corresponding record of outstanding data requests is erased from the Data Request Records storage 32. The previously stored instruction inside the Execution Instructions Records storage 34 receives an indication that the corresponding data packet is now available for processing by the Data Processing Unit 12. As soon as the Computation Module 36 within the Data Processing Unit 12 becomes vacant, it takes one or more data packets from the Elastic Data Buffer 30 and the corresponding instructions from the Execution Instruction Records storage 34, processes the data packet/packets according to the corresponding instructions, and sends the result out. The association of data packets from the Elastic Data Buffer 30 with instructions from the Execution Instruction Records storage 34 can be done either in the order instructions are stored (if data packets are coming in the same order as data requests were previously sent) or according to the address of the unit sending the data packet, such as Data Processing Units 12, Instructions and Data Interface 14, or an external storage device (not shown). (Each unit sends data packets in the same order as data requests are received, although the order of data packets from different units may not be preserved.) In the preferred embodiment, after the Computation Module 36 starts processing the data the corresponding instruction is erased from the Data Request Records storage 32. Then the Computation Module 36 takes the next one or more data packets and corresponding instruction from the Execution Instruction Records storage 34, processes the data, sends the result out and so on.

Each data packet has an associated data token attached to it or associated with it, which establishes the validity of the data packet and serves as a synchronization signal to trigger the processing of the data packet. Thus, synchronization of the parallel operation of the multiprocessor system is driven by the data tokens attached to or associated with the data packets.

Having the instructions distributed to Data Processing Units 12, and data requests sent out, in advance of the actual availability of a Data Processing Unit 12 to process the data, can help to balance the consecutive operation of the Instructions Distributing Unit 18 with parallel work of Data Processing Units 12. Improvement in performance is obtained when rate of instructions distributed by the Instructions Distributing Unit 18 exceeds the rate of data processing by the Data Processing Units 12. This result is achieved by taking advantage of the time difference between the rate of instructions distribution and the rate of data processing, and the utilization of time delays arising from the need to deliver data to the Data Processing Units 12. When the rate of distribution of the instructions does not exceed the rate of data processing, the same improvement in performance may nevertheless be achieved by distributing more than one instruction at a time. By doing so, a rate of distribution of the instructions per instruction which exceeds the rate of data processing for one instruction is obtained.

FIG. 5 illustrates the operation of an Elastic Data Buffer 30. The buffer 30, for example a FIFO buffer, has an input port 30a for receiving data and an output port 30b for sending data out, and several control signals: an incoming signal indicating the validity of incoming data (data token), and outgoing signal indicating the buffer's fullness, an outgoing signal indicating the validity of outgoing data (data token), and an outgoing signal indicating the buffer's emptiness. Asserting the buffer's fullness signal in advance of its actual filling allows for the data packets, which are in transit between the previous unit such as Data Processing Units 12, Instructions and Data Interface 14, or an external storage device (not shown), sending the data and the buffer 30 receiving it, to be absorbed by the receiving buffer 30. Asserting the buffer's emptiness signal in advance of its actual depletion allows for the buffer 30 to ask for subsequent data packets, required for the execution of instructions stored in the Execution Instruction Records storage 34, before the buffer 30 becomes empty. The incoming data validity signal (data token) thus provides data-driven synchronization by the elastic buffer 30 for an incoming data packet, while the outgoing data validity signal (data token) provides data-driven synchronization for each data packet transmitted out of the elastic buffer 30 to another module. The timing of buffer's fullness and emptiness signals can be programmed, which facilitates the management of data behavior inside a particular multiprocessor system according to specific target application.

A preferred embodiment of the present invention has been shown and described by way of example only. It will be apparent to those skilled in the art that changes and modifications may be made without departing from the scope of the invention, as set out in the appended claims.

We claim:

1. A method for data-driven synchronous parallel processing of a stream of data packets by multiple data processing units working in parallel, comprising the steps of:
a. distributing at least one instruction for data processing to one data processing unit of the multiple data processing units, before the data processing unit is available to process the instruction;
b. storing the instruction in an execution instructions memory;
c. sending from the one data processing unit a data request for at least one data packet corresponding to the instruction, required to execute the instruction;
d. storing a record of the at least one data packet requested;
e. associating with the at least one data packet an address of the one data processing unit;
f. associating with the each data packet sent out a data token showing the readiness of the packet for further processing;
g. when the at least one data packet is received by the processing unit, associating the data packet with the corresponding instruction and distributing the data packet to the one data processing unit; and
h. processing the data according to the corresponding instruction.

2. The method of claim 1 wherein instructions are distributed to the multiple data processing units consecutively.

3. The method of claim 1 wherein instructions are distributed to the multiple data processing units concurrently.

4. The method of claim 1 including, after step f., the step of putting the requested data packets into an internal data buffer in a data processing unit.

5. The method of claim 1 including, after step g., the step of erasing the record of the data request corresponding to the data packet.

6. The method of claim 1 including, during step g., the step of sending to the corresponding instruction in the execution instructions memory an indication that the at least one data packet has been received by the processing unit and is available for processing.

7. The method of claim 1 including, during step e., the step of associating with the data packets an address of its sender and, during the step g, associating the data packet with the corresponding instruction according to the address of the data packet sender.

8. The method of claim 1 including, during the step g, associating the data packet with the corresponding instruction according to the order of the data packet received.

9. The method of claim 4 including the step of retrieving each data packet from the internal data buffer to be processed according to the corresponding instruction.

10. The method of claim 1 wherein an output of the processing step is sent to another data processing unit or out of the processor, or both.

11. The method of claim 1 wherein processing occurs in real-time.

12. A method of providing a substantially non-stalling sequential flow of data packets through a digital data-driven processor, the digital processor storing at least one instruction for processing data packets in accordance with the instruction, comprising the steps of:
a. providing a buffer between adjacent units processing, distributing or otherwise handling the data;
b. providing a fullness signal indicating a fullness state of the buffer from the data buffer to a previous adjacent unit, before the buffer is full;
c. providing an emptiness signal indicating an emptiness state of the buffer from the data buffer to a next adjacent unit, before the buffer is empty;
d. providing an incoming data validity signal for synchronization of data handling by the buffer with the arrival of a data packet to the buffer; and
e. providing an outgoing data validity signal for synchronization of data handling by a unit next after the buffer with an outgoing data packet from the buffer,
wherein assertion of the fullness signal in advance of filling the buffer allows the buffer to absorb data packets in transit between a previous unit sending the data and the buffer receiving the data, and assertion of the emptiness signal in advance of depleting the buffer allows for the processor to request new data packets before the buffer becomes empty.

13. The method of claim 12 wherein the validity signal comprises a data token.

14. The method of claim 13 in a processor having a plurality of processing units, including the step of programming a timing of assertion of the fullness signal and of the emptiness signal to allow for management of synchronous data flow to the processing units.

15. An apparatus for substantially non-stalling synchronous data packet flow through a digital data-driven processor, each data packet being associated with an address of a processing unit containing an instruction for processing the data packet, comprising a data buffer for temporary storage of the data packets, the buffer comprising
an input port for receiving incoming data packets and their associated addresses;
an output port for sending out outgoing data and their associated addresses;
an input port for receiving an incoming validity signal;
an output port for sending an outgoing validity signal;
an outgoing fullness signal indicating a fullness of the buffer, adapted to be asserted in advance of the filling of the buffer;
an outgoing emptiness signal indicating an emptiness of the buffer, adapted to be asserted in advance of the depletion of the buffer; and
control logic for regulating a timing of assertion of the fullness and the emptiness signals in a multi-processing system.

16. The apparatus of claim 15 wherein the validity signal comprises a data token.

17. The apparatus of claim 16 wherein the buffer comprises a FIFO buffer.

18. An apparatus for substantially non-stalling data-driven synchronous parallel processing of data packets including a digital data processor, further comprising:
an interface for receiving instructions and digital data from at least one external device and sending instructions or digital data or both to at least one external device;
an instruction path contained inside the processor;
a data path contained inside the processor;
a plurality of data processing units organized for parallel processing of the data; and
a distributing unit organized for distributing one or more instructions at a time to the data processing units.

19. The apparatus of claim 18 wherein instructions are distributed to the plurality of data processing units consecutively.

20. The apparatus of claim 18 wherein instructions are distributed to the plurality of data processing units concurrently.

21. The apparatus of claim 18 wherein each data processing unit comprises
a storage for instructions;
a storage for records of outstanding data requests;
a storage for receiving requested data packets; and
a computation module for processing the requested data packets in accordance with at least one associated instruction.

22. The apparatus of claim 21 comprising control logic for controlling instruction and data flows through the processor.

23. The apparatus of claim 18 wherein the digital data processor comprises a general-purpose microprocessor.

24. The apparatus of claim 18 wherein the digital data processor comprises a graphics processor.

25. The apparatus of claim 18 wherein the digital data processor comprises a digital signal processor.

26. The apparatus of claim 21 wherein the computational module operates using vector values.

27. The apparatus of claim 21 wherein the computational module operates using scalar values.

28. A method for data-driven synchronous parallel processing of a stream of data packets by multiple data processing units working in parallel, comprising the steps of:
a. distributing at least one instruction for data processing to one data processing unit of the multiple data processing units, before the data processing unit is available to process the instruction;
b. storing the instruction in an execution instructions memory;
c. sending from the one data processing unit a data request for at least one data packet corresponding to the instruction, required to execute the instruction;
d. storing a record of the at least one data packet requested;
e. associating with the at least one data packet an address of the one data processing unit;
f. associating with the at least one data packet a data token indicating a readiness of the data packet for further processing and comprising data for associating the at least one data packet with the corresponding instruction at the one data processing unit;
g. when the at least one data packet is received by the processing unit, associating the data packet with the corresponding instruction and distributing the data packet to the one data processing unit; and
h. processing the data according to the corresponding instruction.
